(19) United States
(12) Patent Application Publication
(10) Pub. No.: US 2026/0369142 A1
(43) Pub. Date: Nov. 19, 2026

(54) FIXING DEVICE FOR CAMERA AND SURVEILLANCE APPARATUS THEREOF

(71) Applicant: VIVOTEK INC., New Taipei City (TW)

(72) Inventor: Ching-Ching Chen, New Taipei City (TW)

(73) Assignee: VIVOTEK INC., New Taipei City (TW)

(21) Appl. No.: 19/643,828

(22) Filed: Apr. 10, 2026

(30) Foreign Application Priority Data
May 15, 2025 (TW) 114118284

(51) Int. Cl. G08B 13/196; G03B 17/56; H04N 23/695

(52) U.S. Cl. CPC G08B 13/19632; G03B 17/561; G08B 13/19619; G08B 13/1963; H04N 23/695

(57) ABSTRACT

A fixing device is applied to a camera for forming a surveillance apparatus. The fixing device includes a base, a positioning mechanism and at least one constraining component. The positioning mechanism is disposed on the base and used to engage with a lateral side of the camera. The at least one constraining component is disposed on position of the base opposite to the positioning mechanism. The at least one constraining component includes a constraining portion and a supporting portion. The constraining portion is disposed on a top end of the base. The supporting portion is disposed on a lateral end of the base and spaced from the constraining portion. The constraining portion and the supporting portion are used to engage with the camera.

### BACKGROUND OF THE INVENTION

### 1. Field of The Invention

The present invention relates to a fixing device and a surveillance apparatus, and more particularly, to a fixing device applied to the camera and a related surveillance apparatus.

### 2. Description of The Prior Art

A conventional surveillance apparatus is typically secured to the fixing device on the ceiling or the wall by means of fastening element such as a screw or a bolt, in conjunction with tools including a screwdriver, a wrench, or a fastening bracket. During installation or removal of the camera, the user must hold the camera while simultaneously utilizing the tool to tighten or loosen the screw or the bolt, so as to complete the installation or removal procedure. Taking the installation process as an example, the user must hold the camera with one hand to prevent the camera from falling and align the camera with the mounting hole of the fixing device, and further operate the aforementioned tool with the other hand to drive the screw or the bolt into the mounting hole, thereby completing the installation of the camera. However, in the entire installation process, the user is required to continuously hold the camera while alternately manipulating the tool and the fastening element; the conventional installation or removal of the camera not only renders the operation cumbersome, but also results in low assembly efficiency, and may even lead to the falling risk. Design of a fixing device and a related surveillance apparatus that enable simple, convenient operation and allow rapid installation and removal of the camera is an important issue in the institutional design industry.

### SUMMARY OF THE INVENTION

The present invention provides a fixing device applied to the camera and a related surveillance apparatus for solving above drawbacks.

According to one embodiment, a fixing device is applied to a camera and includes a base, a positioning mechanism and at least one constraining component. The positioning mechanism is disposed on the base and configured to engage with a lateral side of the camera. The constraining component is disposed on position of the base opposite to the positioning mechanism. The constraining component includes a constraining portion and a supporting portion. The constraining portion is disposed on the base. The supporting portion is disposed on the base and located on a lateral end of the constraining portion and spaced from the constraining portion. The constraining portion and the supporting portion are configured to engage with the camera.

According to another embodiment, a surveillance apparatus includes a camera and a fixing device. The device is applied to a camera and includes a base, a positioning mechanism and at least one constraining component. The positioning mechanism is disposed on the base and configured to engage with a lateral side of the camera. The constraining component is disposed on position of the base opposite to the positioning mechanism. The constraining component includes a constraining portion and a supporting portion. The constraining portion is disposed on the base. The supporting portion is disposed on the base and located on a lateral end of the constraining portion and spaced from the constraining portion. The constraining portion and the supporting portion are configured to engage with the camera.

The fixing device of the present invention can be applied for the camera. During installation, the user can first lock the base on the ceiling or the wall. Then, the user can obliquely insert the camera through the constraining portion and the holding portion of the constraining component, and rotate the camera to the preset position, so that the engaging component and the hook of the constraining component of the positioning mechanism can be symmetrically engaged with corresponding position of the outer lateral side of the camera, and connection between the camera and the positioning mechanism and the resilient recovery force of the recovering component of the positioning mechanism can be used to prevent the camera from falling. Therefore, the user does not need to hold the camera with one hand continuously; the user can install or detach the camera from the fixing device of the present invention by using such as the screwdriver, the wrench or the clamp with both hands, thus increasing assembly efficiency and stability. In addition, the present invention can have the groove used to accommodate the wire material of the camera, which can effectively simplify the wiring process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of a surveillance apparatus according to an embodiment of the present invention.

FIG. 2 is a diagram of parts of a fixing device according to the embodiment of the present invention.

FIG. 3 is an exploded diagram of parts of the fixing device according to the embodiment of the present invention.

FIGS. 4 and 5 are enlarged diagrams of parts of the fixing device according to the embodiment of the present invention.

FIGS. 6 and 7 are diagrams of a camera and the fixing device in different assembly modes according to the embodiment of the present invention.

### DETAILED DESCRIPTION

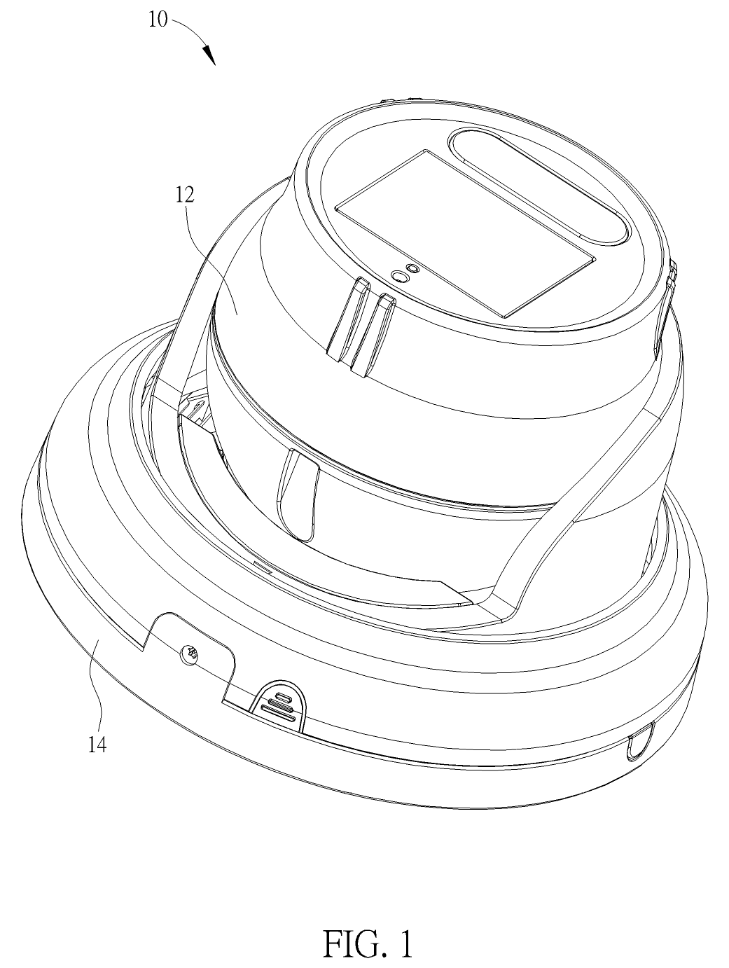

Please refer to FIG. 1. FIG. 1 is an appearance diagram of a surveillance apparatus 10 according to an embodiment of the present invention. The surveillance apparatus 10 can at least include a camera 12 and a fixing device 14. The fixing device 14 can be installed on the wall or the ceiling. The camera 12 can be attached to the fixing device 14 in a detachable manner. Through special design of the fixing device 14 in the present invention, the user can install or detach the camera 12 from the fixing device 14 with one hand, or can adjust an angle of the camera 12 relative to the fixing device 14 with one hand, without having to free up both hands to pick up additional small parts.

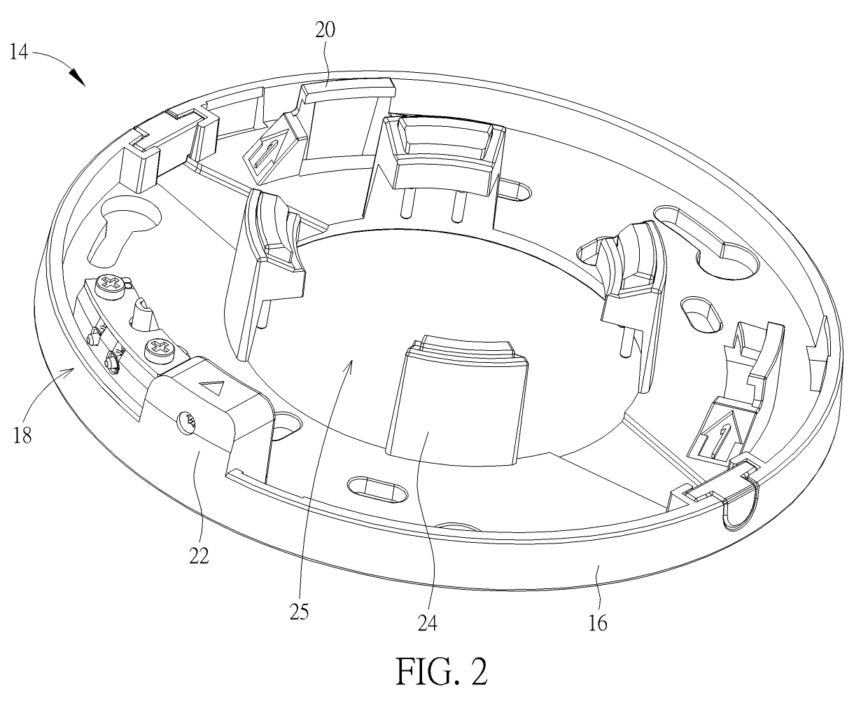

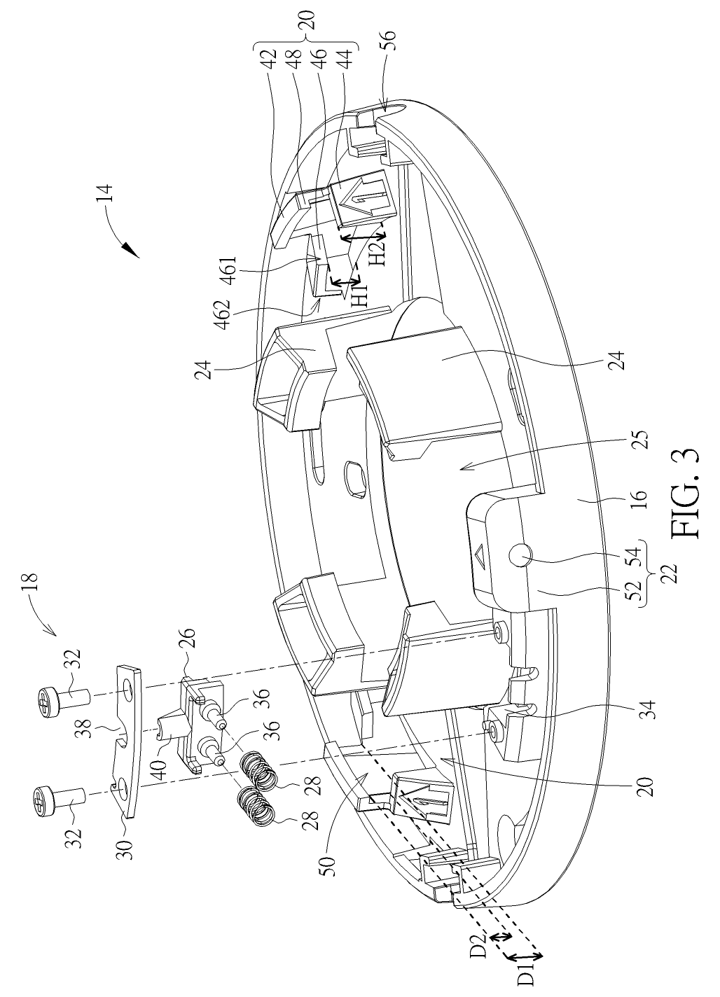

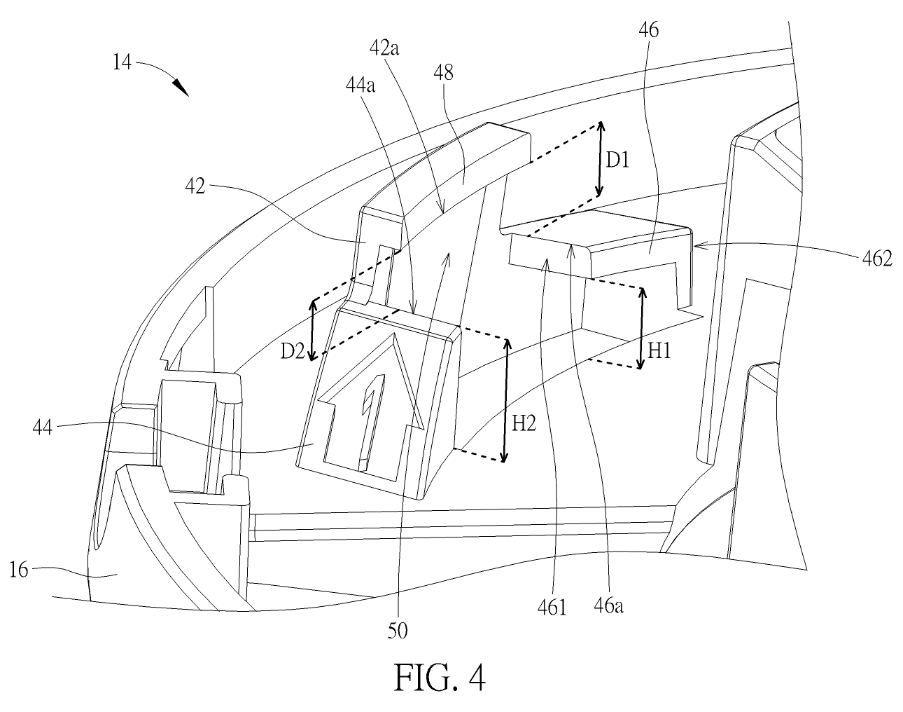

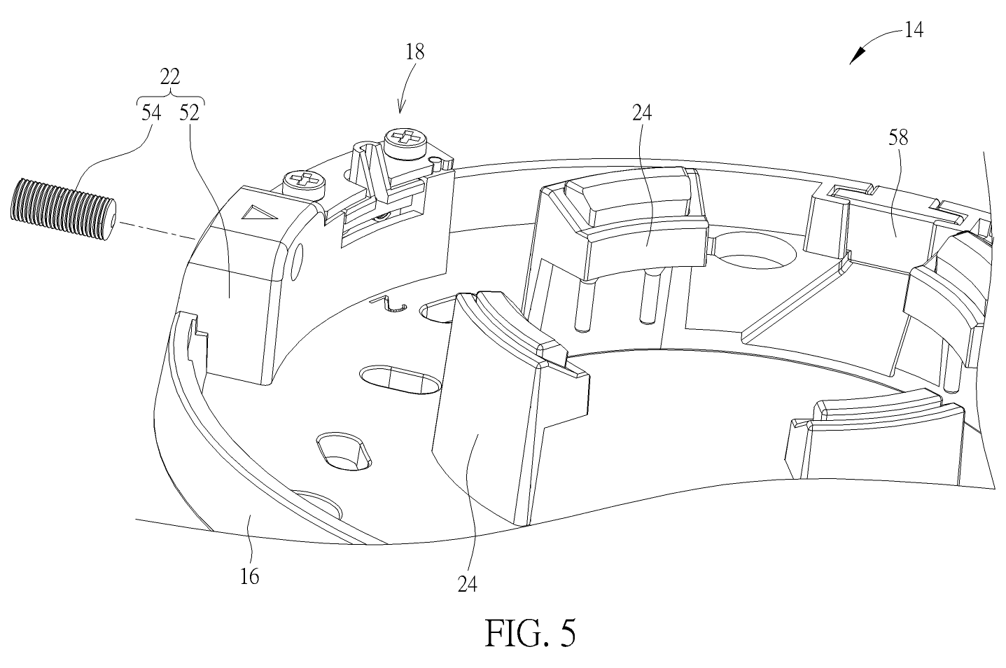

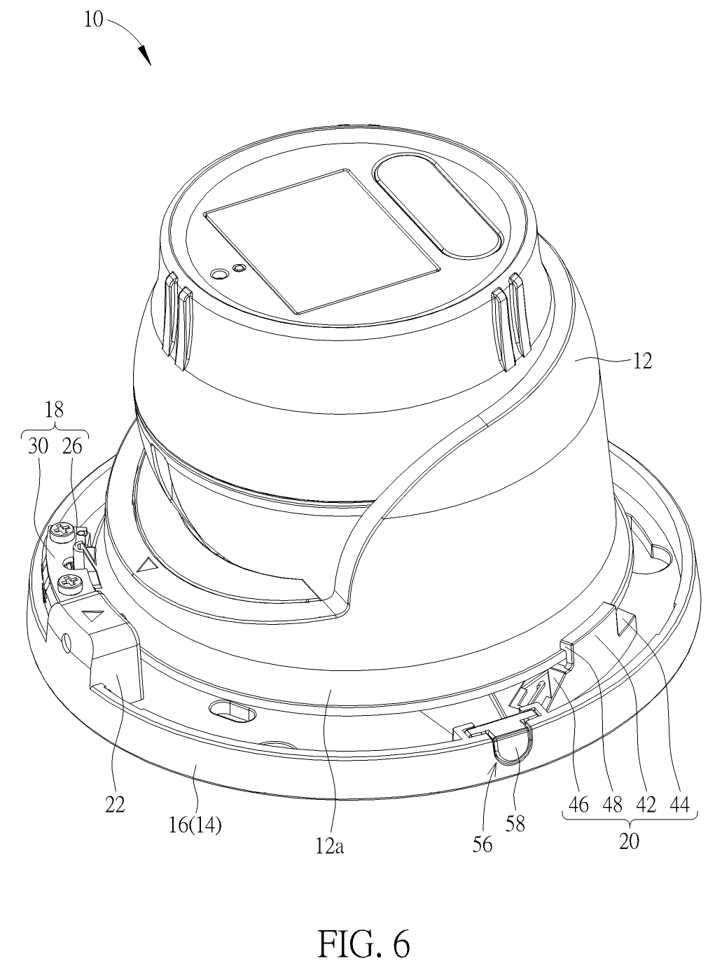

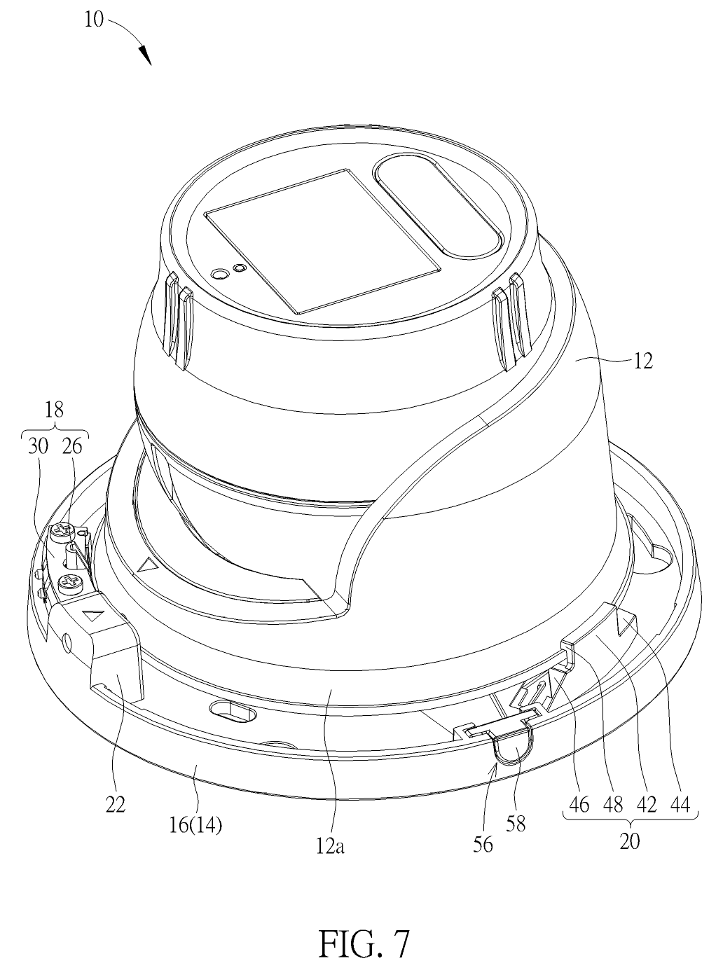

Please refer to FIGS. 2 -7. FIG. 2 is a diagram of parts of the fixing device 14 according to the embodiment of the present invention. FIG. 3 is an exploded diagram of parts of the fixing device 14 according to the embodiment of the present invention. FIGS. 4 and 5 are enlarged diagrams of parts of the fixing device 14 according to the embodiment of the present invention. FIGS. 6 and 7 are diagrams of the camera 12 and the fixing device 14 in different assembly modes according to the embodiment of the present invention. The user can install the fixing device 14 on the ceiling or the wall, and then temporarily attach the camera 12 to the fixing device 14 at an angle, and rotate and align the camera 12 to tightly engage with the fixing device 14.

The fixing device 14 can include a base 16, a positioning mechanism 18, a constraining component 20, a pressing mechanism 22 and a friction component 24. A shape of the base 16 is not limited to the disc shape shown in the figures, and can be changed in accordance with an appearance of the camera 12 and a design demand of the surveillance apparatus 10. An opening 25 can be formed on the center of the base 16. The friction component 24 can be disposed around the edge of the opening 25, but an actual application is not limited thereto. The positioning mechanism 18 can be disposed on the base 16 and configured to engage with a lateral side of the camera 12. In the present invention, the fixing device 14 can preferably have one positioning mechanism 18 and two constraining components 20, which are distributed on symmetrical position of the base 16 corresponding to the lateral side of the camera 12. Numbers and arrangement position of the positioning mechanism 18 and the constraining component 20 can be changed in accordance with the design demand.

The positioning mechanism 18 can include an engaging component 26, a recovering component 28, a restraining component 30 and a locking component 32. The engaging component 26 can be movably disposed inside a notch 34 of the base 16, and configured to abut against the lateral side of the camera 12 for constraining a movement of the camera 12 relative to the fixing device 14. Two ends of the recovering component 28 can respectively abut against the engaging component 26 and the base 16. The recovering component 28 can store a resilient recovery force when the engaging component 26 is pressed by an external force, and the resilient recovery force can be released when the external force is removed from the engaging component 26. In the embodiment, two recovering components 28 can be attached to corresponding convex pillars 36 of the engaging component 26, but an actual application is not limited thereto.

The restraining component 30 can be disposed on the engaging component 26, and configured to constrain a movement of the engaging component 26 relative to the base 16. For example, the restraining component 30 can prevent the engaging component 26 from leaving from the notch 34 of the base 16, and can further control a moving direction of the engaging component 26 when being affected by the external force or the resilient recovery force of the recovering component 28. The locking component 32 can pierce through the restraining component 30 and be locked onto the base 16, so as to fix the restraining component 30 on the base 16. In the embodiment, the restraining component 30 can include a cut structure 38. A column 40 of the engaging component 26 can abut against the cut structure 38 in a slidable manner. When the camera 12 is installed on the fixing device 14 and the engaging component 26 is moved relative to the camera 12, a combination of the cut structure 38 and the column 40 can guide the engaging component 26 to move in a preset direction, so as to avoid a positioning function of the positioning mechanism 18 from failing due to movement deviation.

The constraining component 20 can be disposed on position of the base 16 relative to the positioning mechanism 18, and include a constraining portion 42, a supporting portion 44 and a holding portion 46. As shown in FIG. 4, the constraining portion 42 can be disposed on an upper surface of the base 16. The supporting portion 44 can be disposed on the base 16 and located on a lateral end of the constraining portion 42. An outer edge 44a of the supporting portion 44 can be spaced from an outer edge 42a of the constraining portion 42. The outer edge 42a of the constraining portion 42 can be interpreted as a bottom edge or a side edge of the hook 48. The holding portion 46 can be disposed on the base 16 and located on another lateral end of the constraining portion 42. An outer edge 46a of the holding portion 46 can be spaced from the outer edge 42a of the constraining portion 42.

Besides, the holding portion 46 can be a sloping structure, and therefore an included angle can be formed between a planar normal vector of the holding portion 46 and a planar normal vector of the base 16; an actual value of the included angle can be designed in accordance with the design demand, and a detailed description is omitted herein for simplicity. A height of a high end 461 of the holding portion 46 (which may be interpreted as the outer edge 46a of the sloping structure) relative to the base 16 can be greater than a height of a low end 462 of the holding portion 46 relative to the base 16. The high end 461 can be adjacent to the constraining portion 42. The low end 462 can be away from the constraining portion 42. Any section of the holding portion 46 (which means the sloping structure) can be lower than the supporting portion 44, which means a distance D1 between the holding portion 46 and the constraining portion 42 can be greater than a distance D2 between the supporting portion 44 and the constraining portion 42, or means a maximum vertical distance H1 between the base 16 and an end point (e.g., the high end 461) of the holding portion 46 away from the base 16 can be smaller than or equal to a maximum vertical distance H2 between the base 16 and an end point (which is not marked in the figures) of the supporting portion 44 away from the base 16.

A hook 48 can be disposed on an end (or the high end 461 mentioned as above) of the constraining portion 42 away from the base 16. A free end of the hook 48 can be extended towards the center of the base 16. Therefore, the positioning mechanism 18 can dispose the hook 48 on the constraining portion 42 of the constraining component 20, and further utilize the hook 48 to engage an outer lateral side 12a of the camera 12 after being straightened. As shown in FIG. 4, a limiting space 50 can be formed among the constraining portion 42, the supporting portion 44 and the holding portion 46 of the constraining component 20. The user can insert the camera 12 into the limiting space 50 at an angle, and then rotate the camera 12 to a preset angle to be aligned, so that the camera 12 can be engaged together by the positioning mechanism 18 and the constraining component 20.

The pressing mechanism 22 can be optionally disposed on position of the base 16 adjacent to the positioning mechanism 18, and include a mounting portion 52 and a pushing component 54. The mounting portion 52 can be disposed on the base 16, or can be integrated with the base 16 monolithically, as shown in FIG. 5. The pushing component 54 can be a screw, a bolt, or any similar element. The pushing component 54 can be disposed inside the mounting portion 52 in a rotatable manner, and can detachably abut against and press the lateral side of the camera 12 in a detachable manner, and configured to change an inclined angle of the camera 12 relative to the base 16. An internal thread structure (which is not marked in the figures) can be formed inside an installation hole of the mounting portion 52. An external thread structure (which is not marked in the figures) can be formed on an outer surface of the pushing component 54. The user can rotate the pushing component 54 to change and adjust an extending length of the pushing component 54 relative to the mounting portion 52. The pushing component 54 that is extended from the mounting portion 52 can abut against the lateral side of the camera 12 in a slidable manner.

Moreover, the friction component 24 can be disposed on position of the base 16 facing the camera 12, and configured to abut against the outer surface of the against camera 12 for rotation constraint. In the embodiment, the fixing device 14 can have four friction components 24 distributed on symmetrical position of the base 16, but an actual application is not limited thereto. The fixing device 14 can optionally include a groove 56 formed on the base 16 and configured to accommodate wire material of the camera 12. If there is no wire material inside the groove 56, a decorative element 58 can be optionally applied to cover the groove 56, for preventing dust or liquid from leaking into the fixing device 14. Generally, the groove 56 can be formed on the side edge of the base 16. A shape and a size of the groove 56 can depend on the design demand, and the detailed description is omitted herein for simplicity.

In the preferred embodiment of the present invention, the user can obliquely insert the outer lateral side 12a of the camera 12 into a gap between the constraining portion 42 and the holding portion 46; in the meantime, the inclined angle of the camera 12 may be similar to the inclined angle of the holding portion 46, and the outer lateral side 12a of the camera 12 is not engaged by the engaging component 26 of the positioning mechanism 18. Then, the user can rotate the pushing component 54 of the pressing mechanism 22, and the camera 12 can be pressed by the pushing component 54 and rotated from the inclined angle to a preset position; in the meantime, the outer lateral side 12a of the camera 12 can be separated from the holding portion 46 and engaged between the constraining portion 42 (or the hook 48) and the supporting portion 44, and the engaging component 26 can be pressed by the camera 12 to compress the recovering component 28. As shown in FIGS. 6 and 7, while the camera 12 is rotated to the preset position, the resilient recovery force of the recovering component 28 can push the engaging component 26 to engage with the outer lateral side 12a of the camera 12, thereby completing assembly of the camera 12 and the fixing device 14.

In conclusion, the fixing device of the present invention can be applied for the camera. During installation, the user can first lock the base on the ceiling or the wall. Then, the user can obliquely insert the camera through the constraining portion and the holding portion of the constraining component, and rotate the camera to the preset position, so that the engaging component and the hook of the constraining component of the positioning mechanism can be symmetrically engaged with corresponding position of the outer lateral side of the camera, and connection between the camera and the positioning mechanism and the resilient recovery force of the recovering component of the positioning mechanism can be used to prevent the camera from falling. Therefore, the user does not need to hold the camera with one hand continuously; the user can install or detach the camera from the fixing device of the present invention by using such as the screwdriver, the wrench or the clamp with both hands, thus increasing assembly efficiency and stability. In addition, the present invention can have the groove used to accommodate the wire material of the camera, which can effectively simplify the wiring process.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A fixing device applied to a camera, the fixing device comprising:
a base;
a positioning mechanism disposed on the base and configured to engage with a lateral side of the camera; and
at least one constraining component disposed on a position of the base opposite to the positioning mechanism, the at least one constraining component comprising:
a constraining portion disposed on the base; and
a supporting portion disposed on the base and located on a lateral end of the constraining portion and spaced from the constraining portion, the constraining portion and the supporting portion being configured to engage with the camera.

2. The fixing device of claim 1, wherein the positioning mechanism comprises:
an engaging component movably disposed inside a notch of the base and configured to engage with the lateral side of the camera; and
a recovering component, two ends of the recovering component respectively abutting against the engaging component and the base.

3. The fixing device of claim 2, wherein the positioning mechanism further comprises a restraining component disposed on the engaging component and configured to restrain a movement of the engaging component relative to the base.

4. The fixing device of claim 1, wherein the at least one constraining component further comprises a holding portion disposed on the base and located on another lateral end of the constraining portion, and configured to engage the camera with the constraining portion when the engaging component is not engaged with the camera, an included angle is formed between a planar normal vector of the holding portion and a planar normal vector of the base.

5. The fixing device of claim 4, wherein the holding portion is spaced from the constraining portion, a distance between the holding portion and the constraining portion is greater than a distance between the supporting portion and the constraining portion.

6. The fixing device of claim 1, wherein the fixing device further comprises a pressing mechanism disposed on position of the base adjacent to the positioning mechanism and configured to press the lateral side of the camera, so as to change an inclined angle of the camera relative to the base.

7. The fixing device of claim 6, wherein the pressing mechanism comprises a mounting portion and a pushing component, the pushing component is rotatably disposed inside the mounting portion and configured to detachably abut against the lateral side of the camera in a slidable manner.

8. The fixing device of claim 7, wherein an extending length of the pushing component relative to the mounting portion is changed by rotating the pushing component, the pushing component slidably abuts against the lateral side of the camera.

9. The fixing device of claim 1, wherein the fixing device further comprises a friction component disposed on position of the base facing the camera, and configured to abut against the camera for rotation constraint.

10. The fixing device of claim 4, wherein a hook is disposed on an end of the constraining portion away from the base, an end portion of the hook is extended towards a center of the base.

11. The fixing device of claim 4, wherein a limiting space is formed among the holding portion, the supporting portion and the constraining portion, and configured to engage with the camera.

12. The fixing device of claim 11, wherein a maximum vertical distance between the base and an end point of the holding portion away from the base is smaller than or equal to a maximum vertical distance between the base and an end point of the supporting portion away from the base.

13. A surveillance apparatus comprising:
a camera; and
a fixing device applied to the camera, the fixing device comprising:
a base;
a positioning mechanism disposed on the base and configured to engage with a lateral side of the camera; and
at least one constraining component disposed on a position of the base opposite to the positioning mechanism, the at least one constraining component comprising:
a constraining portion disposed on the base; and
a supporting portion disposed on the base and located on a lateral end of the constraining portion and spaced from the constraining portion, the constraining portion and the supporting portion being configured to engage with the camera.

14. The surveillance apparatus of claim 13, wherein the positioning mechanism comprises an engaging component and a recovering component, the engaging component is movably disposed inside a notch of the base and configured to engage with the lateral side of the camera, two ends of the recovering component respectively abutting against the engaging component and the base.

15. The surveillance apparatus of claim 14, wherein the positioning mechanism further comprises a restraining component disposed on the engaging component and configured to restrain a movement of the engaging component relative to the base.

16. The surveillance apparatus of claim 13, wherein the at least one constraining component further comprises a holding portion disposed on the base and located on another lateral end of the constraining portion, and configured to engage the camera with the constraining portion when the engaging component is not engaged with the camera, an included angle is formed between a planar normal vector of the holding portion and a planar normal vector of the base.

17. The surveillance apparatus of claim 16, wherein the holding portion is spaced from the constraining portion, a distance between the holding portion and the constraining portion is greater than a distance between the supporting portion and the constraining portion.

18. The surveillance apparatus of claim 13, wherein the fixing device further comprises a pressing mechanism disposed on position of the base adjacent to the positioning mechanism and configured to press the lateral side of the camera, so as to change an inclined angle of the camera relative to the base.

19. The surveillance apparatus of claim 18, wherein the pressing mechanism comprises a mounting portion and a pushing component, the pushing component is rotatably disposed inside the mounting portion and configured to detachably abut against the lateral side of the camera in a slidable manner.

20. The surveillance apparatus of claim 19, wherein an extending length of the pushing component relative to the mounting portion is changed by rotating the pushing component, the pushing component slidably abuts against the lateral side of the camera.

21. The surveillance apparatus of claim 13, wherein the fixing device further comprises a friction component disposed on position of the base facing the camera, and configured to abut against the camera for rotation constraint.

22. The surveillance apparatus of claim 16, wherein a hook is disposed on an end of the constraining portion away from the base, an end portion of the hook is extended towards a center of the base.

23. The surveillance apparatus of claim 16, wherein a limiting space is formed among the holding portion, the supporting portion and the constraining portion, and configured to engage with the camera.

24. The surveillance apparatus of claim 23, wherein a maximum vertical distance between the base and an end point of the holding portion away from the base is smaller than or equal to a maximum vertical distance between the base and an end point of the supporting portion away from the base.
